(19) United States
(12) Patent Application Publication
(10) Pub. No.: US 2008/0246913 A1
(43) Pub. Date: Oct. 9, 2008

(54) Hook components with nylon strings elasticity mechanism for eyeglasses

(76) Inventor: Wan Kwong Wong, Hong Kong (CN)

Correspondence Address: JACOBSON HOLMAN PLLC, 400 SEVENTH STREET N.W., SUITE 600, WASHINGTON, DC, 20004, US

(21) Appl. No.: 11/730,752

(22) Filed: Apr. 3, 2007

(51) Int. Cl. G02C 9/00; G02C 1/00

(52) U.S. Cl. 351/47; 351/41

(57) ABSTRACT

A detachable eyewear is designed for eyeglasses. The detachable eyewear is designed similar to an eyeglass frame without temples, which comprises lenses, a rim and two tension adjustment stoppers with hooks each positioned to the respective extensions at the two ends of the rim and each of the tension adjustment stopper is connected by a nylon string, wherein said detachable eyewear is attached in front of the primary eyeglasses. With the flexibility and elasticity endowed with nylon strings, the tension adjustment stoppers with hooks at each end can be opened although they are fixed onto the two ends of the rim. By way of the elastic force, said detachable eyewear adapted to be attached and secured by said hooks of the tension adjustment stoppers to said eyeglasses, either clip-on or clip-off the studs. The detachable eyewear is specially designed which can be in a number of prescriptions. This detachable eyewear is handled easily and attached stably.

A detachable eyewear is designed for eyeglasses. The detachable eyewear is designed similar to an eyeglass frame without temples, which comprises lenses, a rim and two tension adjustment stoppers with hooks each positioned to the respective extensions at the two ends of the rim and each of the tension adjustment stopper is connected by a nylon string, wherein said detachable eyewear is attached in front of the primary eyeglasses. With the flexibility and elasticity endowed with nylon strings, the tension adjustment stoppers with hooks at each end can be opened although they are fixed onto the two ends of the rim. By way of the elastic force, said detachable eyewear adapted to be attached and secured by said hooks of the tension adjustment stoppers to said eyeglasses, either clip-on or clip-off the studs. The detachable eyewear is specially designed which can be in a number of prescriptions. This detachable eyewear is handled easily and attached stably.

### BACKGROUND OF THE INVENTION

This invention relates to a detachable eyewear using nylon strings as the main source of connection, and more particularly, a pair of eyeglasses having a pair of auxiliary sunglasses without temples or an ornament similar to an eyeglass frame mounted thereon which can be easily attached to and detached from eyeglasses frame.

Nowadays eyeglasses, no matter frames are made of metal or plastic, using magnet to attach a pair of auxiliary sunglasses to a pair of primary eyeglasses is a very popular and common method for connecting two eyeglasses. These magnetic clip-on or hook-up methods of connection have long been used as the measures to transform primary eyeglasses into sunglasses without changing the primary optical eyeglasses. One can simply dispose a pair of clip-on or hook-up auxiliary sunglasses in front of the primary optical eyeglasses. Very often, the attachment is merely a pair of sunglasses and is limited to certain prescriptions of eyeglass frames in order to match with the primary eyeglasses.

The present invention arises to provide a new and novel configuration to ordinary eyeglasses so as to match with one's taste and sense of fashion.

### SUMMARY OF THE INVENTION

In a first aspect of the present invention, a detachable eyewear comprises a pair of auxiliary sunglasses or an ornament which appearance is similar to an eyeglass frame but with no lenses mounted thereon. One or two tension adjustment stopper(s) is/are located at both ends of said auxiliary sunglasses with no temple or said ornament with no temple and lenses attachable to said primary eyeglasses. Each tension adjustment stopper is connected by a nylon string.

A second aspect of the present invention is that the tension adjustment stopper not only functions as the media in linking up the lenses of said auxiliary sunglasses or said ornament, but the media to attach said auxiliary sunglasses or said ornament onto a pair of primary eyeglasses through a simple theory of mechanics.

A third aspect of the present invention is to provide a trendy fashion for eyeglasses in which one may change the pattern of one's primary optical eyeglasses by disposing said auxiliary sunglasses or said ornamental frame in front of the primary frame, whilst said auxiliary sunglasses or said ornamental frame can be made in whatever prescription or color in order to match with one's daily style of fashion. This inventive method of connecting auxiliary or ornamental frame to primary eyeglasses is different from that of ordinary clip-ons because it is basically using tension adjustment stoppers and nylon strings and not magnets.

This invention includes the following:

Firstly, a pair of ordinary primary eyeglasses, either made of metal or plastic materials, and said auxiliary sunglasses or said ornament comprises two sides each having a tension adjustment stopper linked by a nylon string. The tension adjustment stopper has two elongated portions extending backwardly with a hook at each end. The nylon string is used to connect the tension adjustment stopper and the lens of said auxiliary sunglasses or said ornament.

Secondly, this invention is to provide an auxiliary sunglasses or an ornament adapted to be attached to primary eyeglasses in specific prescriptions.

### BRIEF DESCRIPTION OF THE DRAWINGS

FIG. 1 is a front view of the mechanism of a tension adjustment stopper linked with a nylon string of the present invention.

FIG. 2 is a side perspective view of the mechanism of a tension adjustment stopper with nylon string.

FIG. 3 is a perspective view of the tension adjustment stopper.

FIG. 4 is a front view of a pair of clip-on sunglasses or the ornament with the tension adjustment stopper having nylon strings levied at both ends according to the present invention.

FIG. 5 is a front view of a pair of ordinary eyeglasses.

FIG. 6 is a front view of a pair of the clip-on sunglasses or the ornament mounted onto said pair of ordinary eyeglasses according to the present invention.

FIG. 7 is a side view of FIG. 6.

FIG. 8 is a top view of the clip-on sunglasses or the ornament with the tension adjustment stopper at both ends.

FIG. 9 is a top view of the clip-on sunglasses or the ornament showing the elongated portions with hooks at both ends can be opened outwardly.

FIG. 10 is a top perspective view of a pair of ordinary eyeglasses with the clip-on sunglasses or the ornament mounted on it.

FIG. 11 is a back perspective view of FIG. 10.

FIG. 12 is a front view of the mechanism of the tension adjustment stopper linked with a nylon string.

FIG. 13 is side perspective view of the mechanism of the tension adjustment stopper linked with a nylon string.

FIG. 14 is a perspective view of the tension adjustment stopper.

FIG. 15 is a front view of the clip-on eyewear with the tension adjustment stoppers at four corners according to a second preferred embodiment of the present invention.

FIG. 16 is a front view of a pair of ordinary eyeglasses.

FIG. 17 is a front perspective view of the clip-on eyewear mounted onto a pair of ordinary eyeglasses according to the above second preferred embodiment of the present invention.

FIG. 18 is a side view of the clip-on eyewear with the tension adjustment stoppers at top and bottom.

FIG. 19 is a side view of the clip-on eyewear showing the elongated portion with hook of the tension adjustment stoppers can be opened outwardly by the mechanism of the present invention.

FIG. 20 is a side view of FIG. 17 showing how the elongated portion with hook of the tension adjustment stoppers are closed and mounted onto a pair of ordinary eyeglasses according to the above second preferred embodiment.

FIG. 21 is a top view of the clip-on eyewear with the tension adjustment stopper at each end.

FIG. 22 is a top view of the clip-on eyewear showing the elongated portion with hook of the tension adjustment stoppers on the top can be pulled upwardly.

FIG. 23 is a top perspective view of the clip-on eyewear mounted onto a pair of ordinary eyeglasses.

FIG. 24 is a back perspective view of the clip-on eyewear mounted onto a pair of ordinary eyeglasses with the tension adjustment stopper (having one elongated portion with hook) at four corners of said ordinary eyeglasses according to the above second preferred embodiment.

FIG. 25 is a front view of the mechanism of the tension adjustment linked with a nylon string according to a third preferred embodiment of the present invention.

FIG. 26 is a side perspective view of FIG. 25.

FIG. 27 is a perspective view of FIG. 25.

FIG. 28 is a front view of the clip-on eyewear with the tension adjustment stopper on the bridge portions according to a third preferred embodiment of the present invention.

FIG. 29 is a front view of a pair of ordinary eyeglasses.

FIG. 30 is a front perspective view of the clip-on eyewear mounted onto a pair of ordinary eyeglasses according to the above third preferred embodiment of the present invention.

FIG. 31 is a side view of FIG. 30.

FIG. 32 is a top view of FIG. 28 showing the clip-on eyewear with the tension adjustment stoppers on the bridge portions.

FIG. 33 is a top view of FIG. 32 showing how the movement of the elongated portion with hook by the mechanism of the tension adjustment stopper with nylon string.

FIG. 34 is a top view of the clip-on eyewear mounted onto a pair of ordinary eyeglasses according to the above third preferred embodiment.

FIG. 35 is a back perspective view of FIG. 34.

FIG. 36 is a front view of the mechanism of the tension adjustment stopper linked with a nylon string according to a fourth preferred embodiment of the present invention.

FIG. 37 is a side perspective view of FIG. 36.

FIG. 38 is a perspective view of the mechanism of the tension adjustment stopper.

FIG. 39 is a front view of the clip-on ornament with the tension adjustment stopper at both ends according to a fourth preferred embodiment of the present invention.

FIG. 40 is a front view of a pair of ordinary eyeglasses.

FIG. 41 is a front view of the clip-on ornament mounted onto a pair of ordinary eyeglasses in which the outlook of the ordinary eyeglasses is changed according to the above fourth preferred embodiment.

FIG. 42 is a side view of FIG. 41.

FIG. 43 is a top view of the clip-on ornament with the tension adjustment stopper at each end.

FIG. 44 is a top view of FIG. 39 showing the movement of the elongated portion with hook of the tension adjustment stoppers on both ends.

FIG. 45 is a top view of FIG. 41 wherein the clip-on ornament is mounted onto a pair of ordinary eyeglasses according to the above fourth preferred embodiment.

FIG. 46 is a back view of FIG. 41.

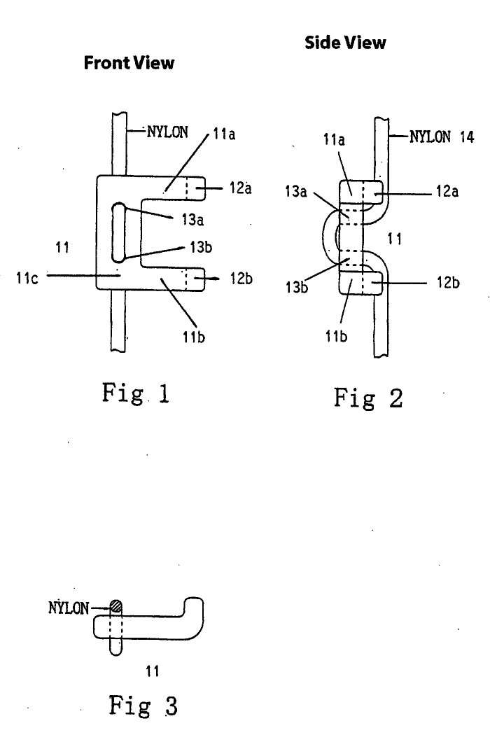

### DETAILED DESCRIPTION OF THE PRESENT INVENTION

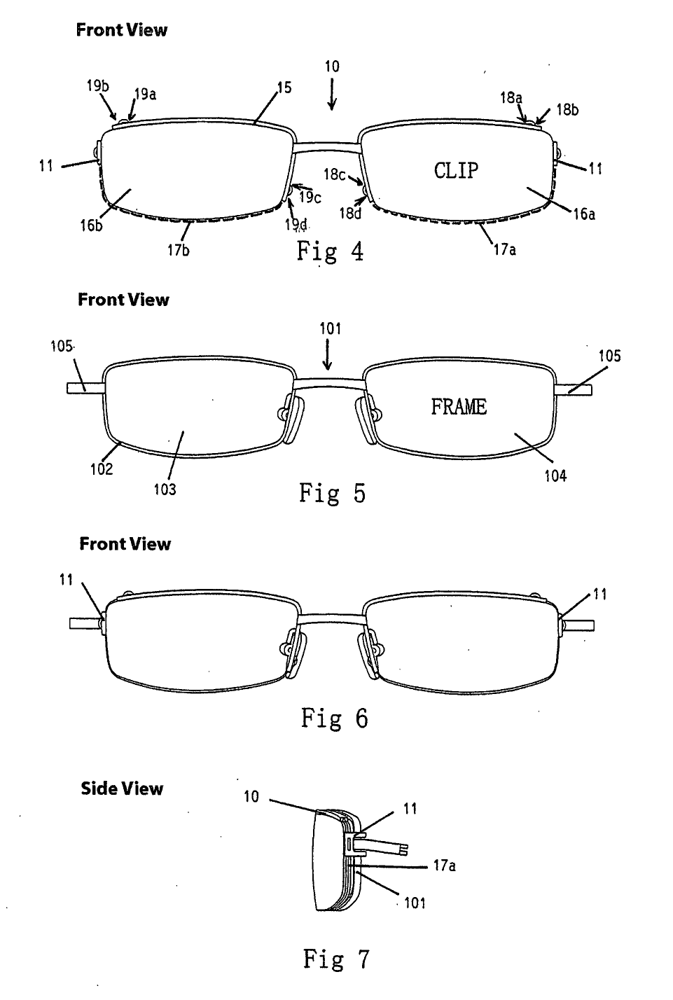

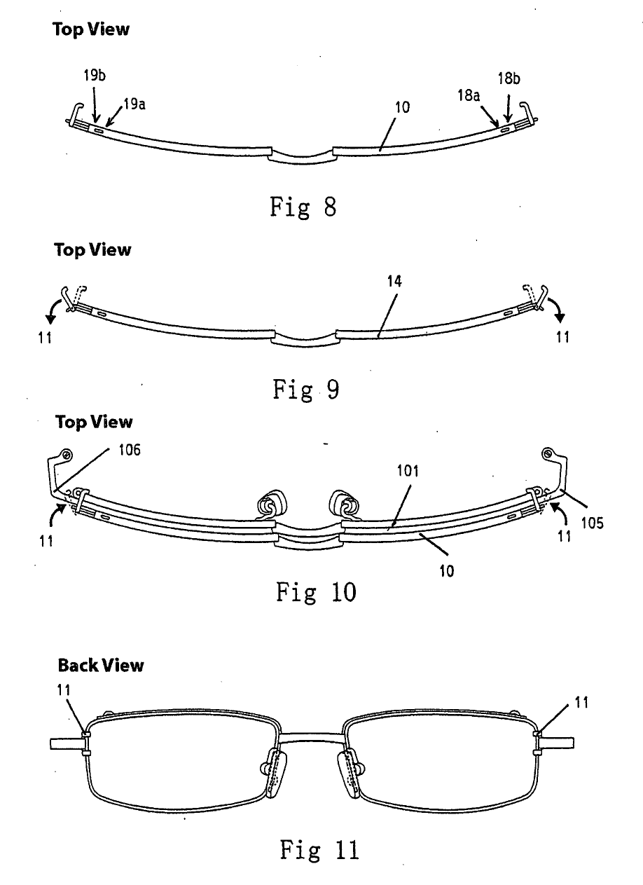

A mechanical tension adjustment stopper 11 of the present invention, referring to FIG. I and FIG. 2, consists of a U-shape rectangular clip-like device with two elongated portions 11a, 11b in equal length and the two ends extended backwardly forming two hooks 12a, 12b. The rectangular base portion 11c of the tension adjustment stopper has two string-receiving apertures 13a, 13b and these two apertures are located within the two elongated portions. FIG. 2 illustrates a nylon string 14 is threaded through the bottom of one string-receiving aperture 13a to the top and is then threaded through the top of another string-receiving aperture 13b to the bottom of rectangular base portion of the tension adjustment stopper 11. The tension adjustment stopper 11 can be constructed from metal or plastic and the hooks of the elongated portions 11a, 11b are installed with slipcover of plastic. In accordance with this invention, FIG. 4 to FIG. 7 illustrates how the tension adjustment stopper with nylon string is linked to a pair of auxiliary clip-on sunglasses and to attach to a pair of primary eyeglasses. A pair of ordinary eyeglasses 101 as shown in FIG. 5 comprises a primary frame 102, lenses 103, 104 mounted within the frame 102. FIG. 4 is a pair of clip-on sunglasses with two tension adjustment stoppers 11 at each end of the frame 15. Each lens of the clip-on sunglasses 16a, 16b has a string-receiving groove 17a, 17b which opens through the outer peripheral rim surface. To connect the lens 16a and a tension adjustment stopper 11 to the right-side rim of the clip-on sunglasses, two tension adjustment locking apertures 18a, 18b are pre-cast at the right top end of the frame 15 and another two tension adjustment locking apertures 18c, 18d are pre-cast at the left bottom end of the frame 15. Thereafter, one end portion of the nylon string 14 is threaded through the first tension adjustment locking aperture 18b from bottom to top, and is then threaded through the second tension adjustment locking aperture 18a from top to bottom. The other end portion of the nylon string 14 extends with tension to reach the first tension adjustment stopper 11 at the right-top end portion of the frame 15. To link up and fasten the tension adjustment stopper 11, the nylon string 14 is threaded through from bottom to top of one string-receiving aperture and is then immediately threaded through from top to bottom of another string-receiving aperture. Said end portion of the nylon string 14 then further extends with tension to reach the second tension adjustment locking point at the left bottom of the rim. Similarly, said end portion of the nylon string 14 is threaded through from bottom to top of one string-receiving locking aperture 18d and is then immediately threaded the other string-receiving locking aperture 18c. The end portions of the nylon string are placed underneath the frame after they have passed through the tension adjustment locking apertures on the frame of the clip-on sunglasses. Both end portions of the nylon string 14 may either be cut off at a certain length apart from the tension adjustment locking points, or extended to connect with each other. The lens 16a, 16b embodying the present invention is formed with a string-receiving groove 17a, 17b which opens through the outer peripheral rim surface. The string-receiving grooves 17a, 17b, which is formed, for example, cut or punched, extend inwardly around the peripheral surface. The width of the string-receiving groove, in the circumferential direction of the lens, is slightly greater than that the diameter of the nylon string, and the inner end of the string-receiving groove is radiused and chamfered, beveled and padded to minimize stresses on, and chafing of, the nylon string. Flowing from the first tension adjustment locking point 18a on the right top to the second tension adjustment locking point 18c on the left bottom, the nylon string lies wholly within the string-receiving groove on the peripheral surface of the lens. A similar method will be applied to connect the lens 16b and the tension adjustment stopper 11 on the left-side rim of the clip-on sunglasses but the tension adjustment locking apertures will be pre-cast at left top end portion 19a, 19b and at right bottom end portion 19c, 19d of the frame of the clip-on sunglasses.

By this methodology, a nylon string can produce a tensile force and this tensile force not only can tie up the lens of the clip-on sunglasses but to connect the tension adjustment stoppers in such a simple way. To attach the clip-on sunglasses 10 to the primary eyeglasses 101, the elongated portions 11a, 11b of the tension adjustment stoppers are inserted to the extensions 105, 106 at both ends of the primary eyeglasses 101, in manner that the upper elongated portion Ha is placed onto the extension 105 and the lower elongated portion 11b is placed below the extension 105 and the hooks 12a, 12b of the elongated portions 11a, 11b hold the extensions 105 of the primary eyeglasses 101 as shown in FIG. 7. FIG. 6 illustrates the clip-on sunglasses 10 is mounted onto a pair of primary eyeglasses 101 of a first preferred embodiment.

As everyone may know, nylon sting has an innate elastic force. The inherent elastic force of nylon string enables the tension adjustment stoppers can be opened inwardly or outwardly although the tension adjustment stoppers are fixed and tied firmly by the nylon strings at both ends of the clip-on sunglasses. If the tension adjustment stoppers are fixed to the lenses or the frame of the clip-on sunglasses by screws or glue solutions, no elastic force can be generated. FIG. 9 illustrates the tension adjustment stopper 11 at both ends of the clip-on sunglasses can be opened outwardly under the connection mechanism of the present invention. To attach the clip-on sunglasses 10 to the primary eyeglasses 101, it is simply to place the clip-on sunglasses in front of the primary eyeglasses 101 and to open the elongated portions of the tension adjustment stoppers 11 outwardly at both ends and to close the elongated portions after they are inserted to the extensions 105 of the primary eyeglasses 101. FIG. 11 illustrates that the elongated portions of the tension adjustment stoppers are inserted to the extensions of the primary eyeglasses whilst both ends of the primary frame are grasped by the hooks 12a, 12b of the tension adjustment stoppers.

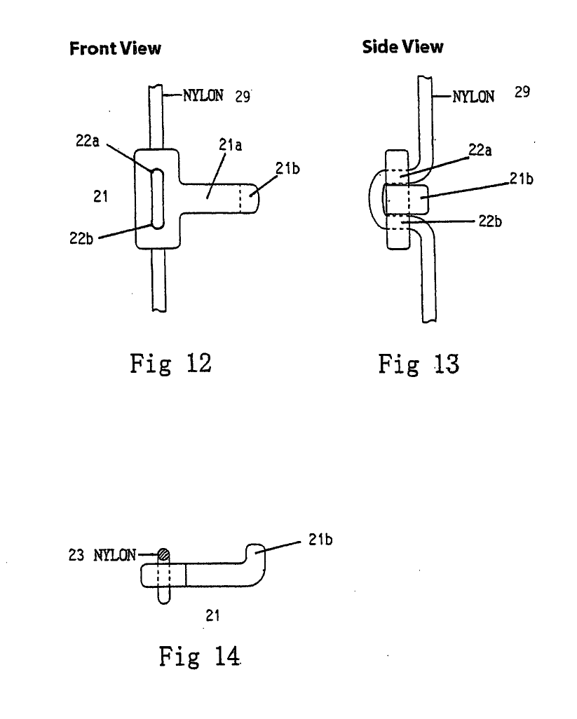

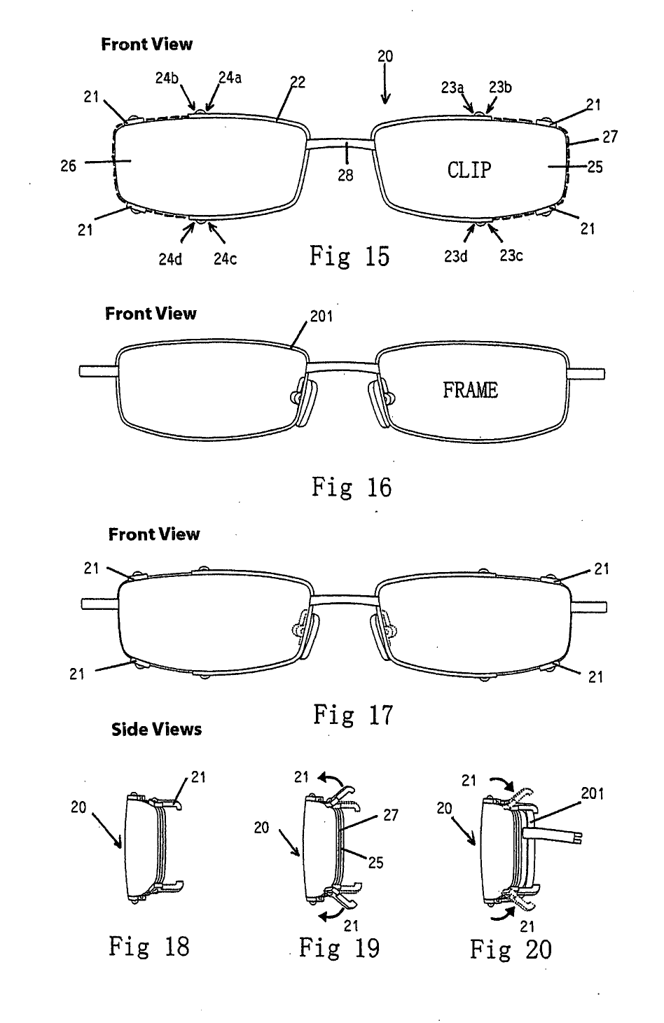

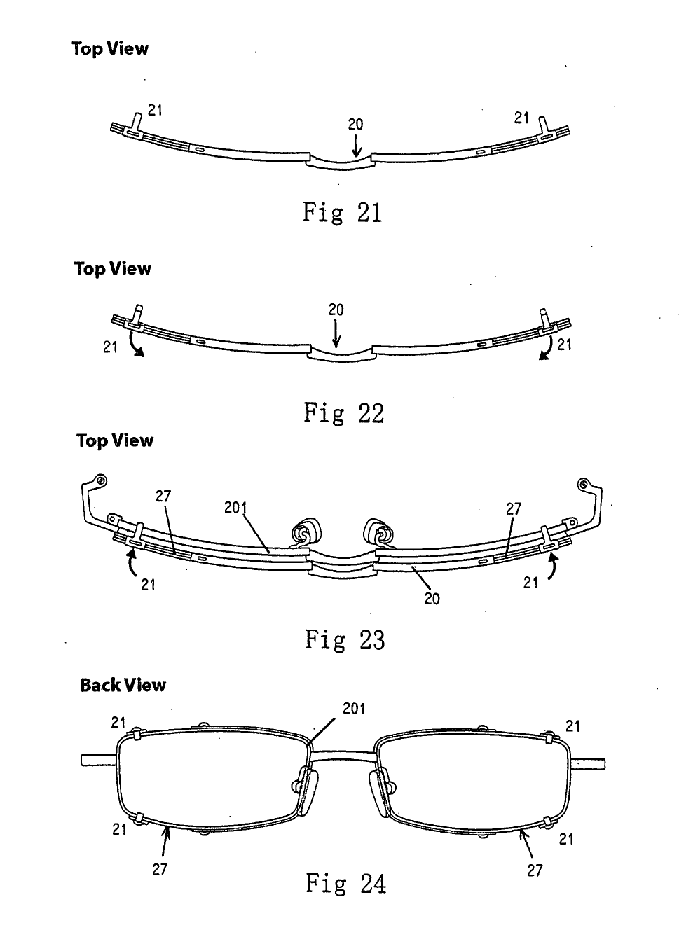

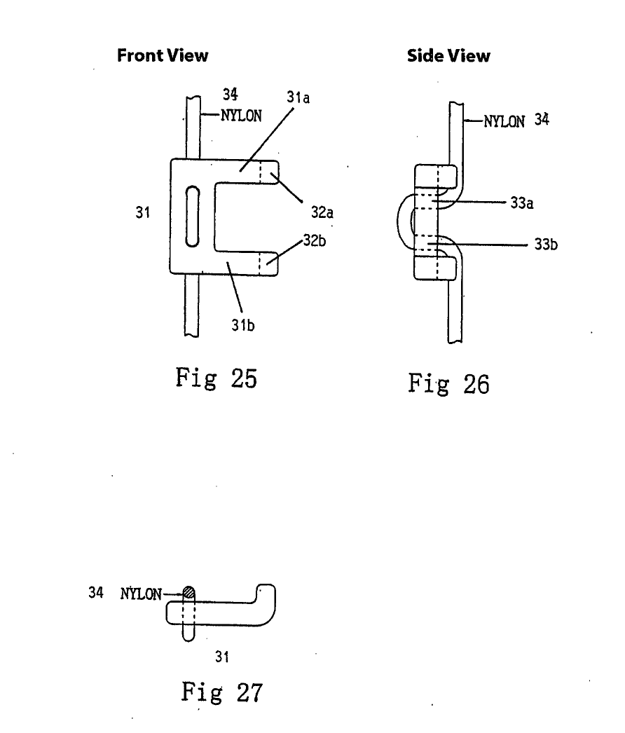

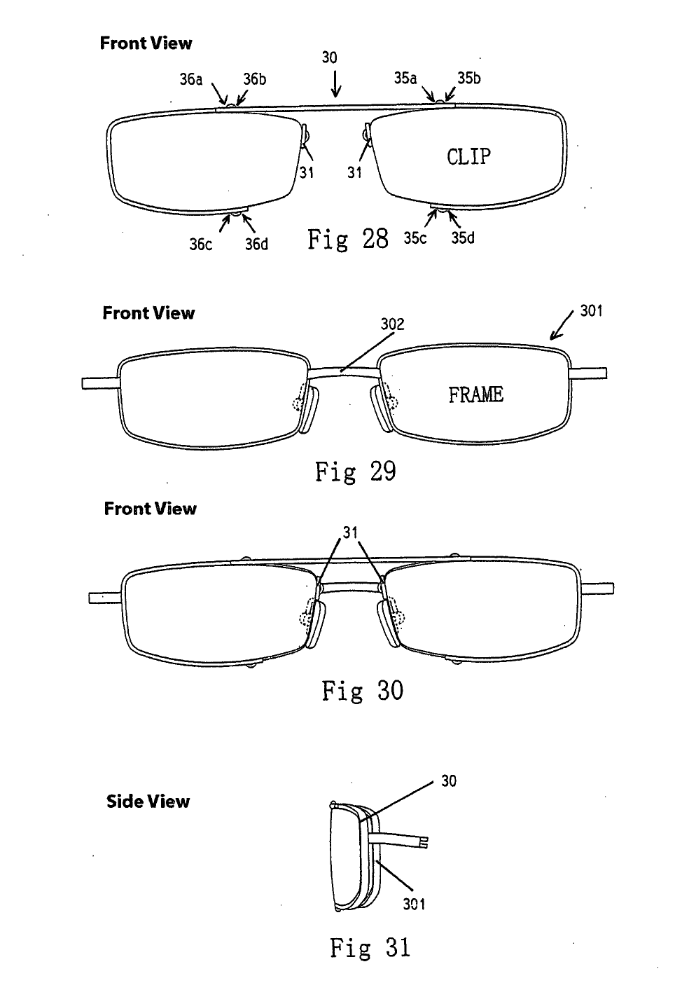

FIG. 12 to 24 illustrates the second embodiment of the present invention having four tension adjustment stoppers are applied to the clip-on sunglasses. The shape of the tension adjustment stopper 21 in the preferred embodiment is not the same as the one applied in the first embodiment. This tension adjustment stopper consists of a T-shape rectangular clip-like device with one elongated portion 21a extended backwardly forming a hook 21b. The rectangular base portion of the tension adjustment stopper has two apertures 22a, 22b and the elongated portion sits in the centre of these two apertures. FIG. 13 illustrates a nylon string 23 is threaded through from bottom to top of one aperture 22a to another aperture 22b of rectangular base portion of the tension adjustment stopper. The length of the rectangular base portion of this tension adjustment stopper 21 is short than the tension adjustment stopper 11 applied in the first embodiment. As in the first embodiment, this tension adjustment stopper can also be constructed from metal or plastic and the end portion of the elongated portion wears a slipcover of plastic. Each lens of the clip-on device 20 is equipped with two tension adjustment stoppers 21. On the right 25, the tension adjustment stoppers 21 are placed at the corners on the right top and bottom of the lens where two other tension adjustment stoppers 21 are placed at the corners on the left top and bottom of the lens on the left 26. The design of the frame 20, looking like a character “C” and a reverse “C” linking by a bridge portion 28, is different from that of the one in the first embodiment. A first tension adjustment locking point having two locking apertures 23a, 23b of a nylon string starts at the top right end portion of the rim. One end portion of the nylon string 29 is threaded through from bottom to top of one locking aperture 23b and is then threaded through from top to bottom of another locking aperture 23a to constitute a locking point. The nylon string 29 extends to pass through a first tension adjustment stopper 21 on the right top, a second tension adjustment stopper 21 on left bottom and finally reaches the second tension adjustment locking point at the end portion of the frame. The second tension adjustment locking point has two locking apertures 23c, 23d. Similarly, the end portion of the nylon string 29 is threaded through from bottom to top of one locking aperture 23c and is then threaded through the other locking aperture 23d to complete the connection of the of the tension adjustment stoppers and the lens 25 on the right. A similar method is method is applied to connect the tension adjustments stoppers 21 and the lens 26 on the left. FIG. 18 to 20 illustrate that the tension adjustment stoppers 21 can be opened upwardly and, when the sunglasses is mounted onto the primary eyeglasses 201, and the hooks 21b of the elongated portion 21a is able to grasp the frame of the primary eyeglasses 201. Similar to the first embodiment, each lens of the clip-on device has a string-receiving groove 26 which opens through the outer peripheral rim surface. From the back view as shown in FIG. 24, it clearly shows that the hooks 21b of the elongated portions 21a of the tension adjustment stoppers 21 are placed and grasped the frame of the primary eyeglasses 201. In this preferred embodiment, the attachment support from the extensions of the frame of the primary eyeglasses is not avoided.

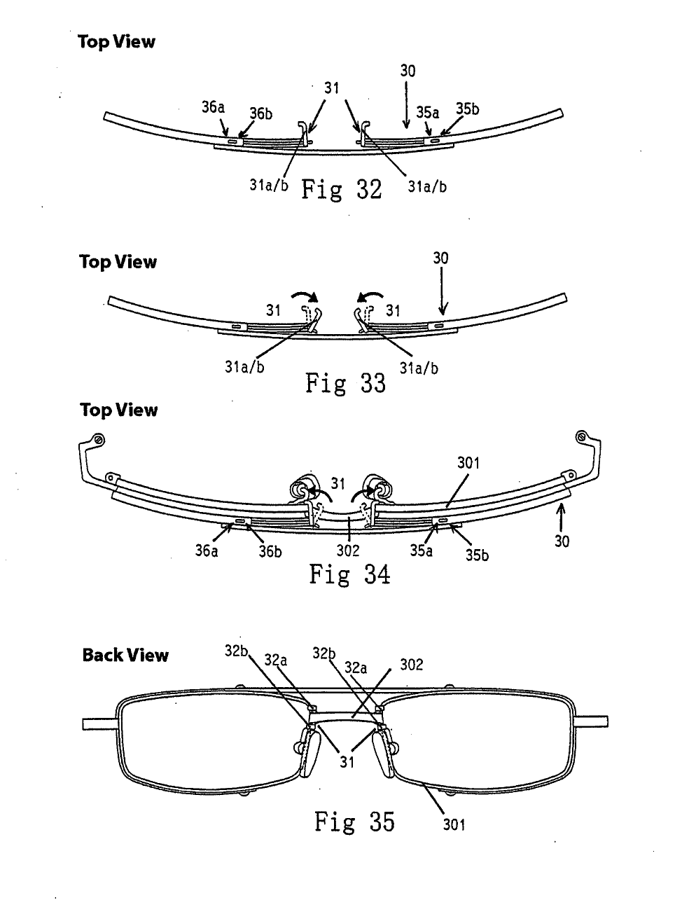

In the third preferred embodiment, the tension adjustment stopper 31 applied in this embodiment is the same as the one applied in the first embodiment but the design of the clip-on device is again different from the above two embodiments. The bridge portion of the clip-on device 30 is omitted. Two tension adjustment stoppers 31 are utilized in this embodiment and they are placed at the positions which normally for fitting a bridge. For the lens on the right, the start-locking point of a nylon sting 34 will be at the top portion of the rim in which two locking apertures 35a, 35b are made. After one end portion of the nylon string 34 is passed through the locking apertures 35a, 35b in accordance with the method as above mentioned at top of the frame, the other end portion of the nylon string 34 extends to meet the tension adjustment stopper 31, and further extends to reach the end-locking point. Similar to the measures taken in the start-locking point, another two locking apertures 35c, 35d are made at the bottom end portion of the frame. The support of the clip-on sunglasses rests on the bridge portion 302 of the primary eyeglasses. Referring to FIG. 32 to 35, to attach the clip-on device 30 to the primary eyeglasses 301, users should put the clip-on device 30 in front of the primary eyeglasses 301 and to pull out the elongated portions 31a of the tension adjustment stoppers 31 at bridge portion and the clip-on device 30 will be mounted onto the primary eyeglasses 301 by the closing of the elongated portions 31a of the tension adjustment stoppers 31. The elongated portions 31a will be inserted to the bridge 302 of the primary eyeglasses 301 where the upper elongated portion of the tension adjustment stopper 31 is seated on the bridge whilst the lower elongated portion is below the bridge. The frame of the primary eyeglasses will be seized by the hooks 31b of the elongated portions 31a of the tension adjustment stoppers as shown in FIG. 35.

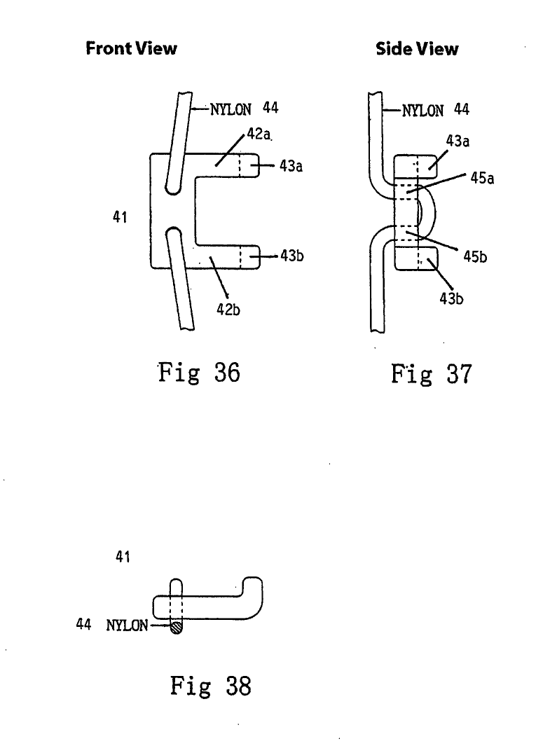

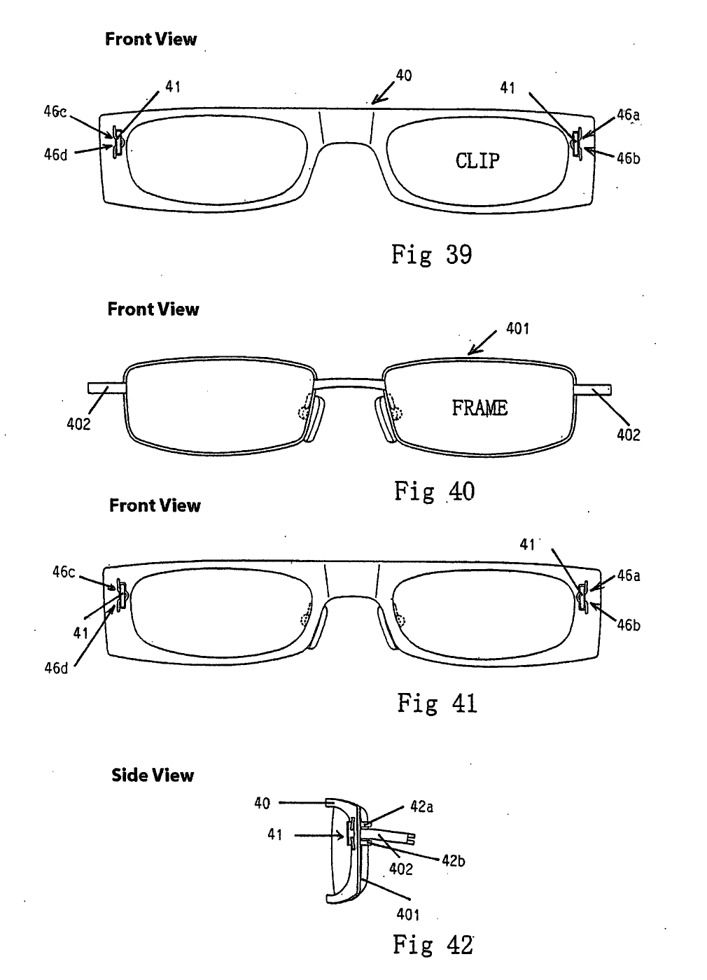

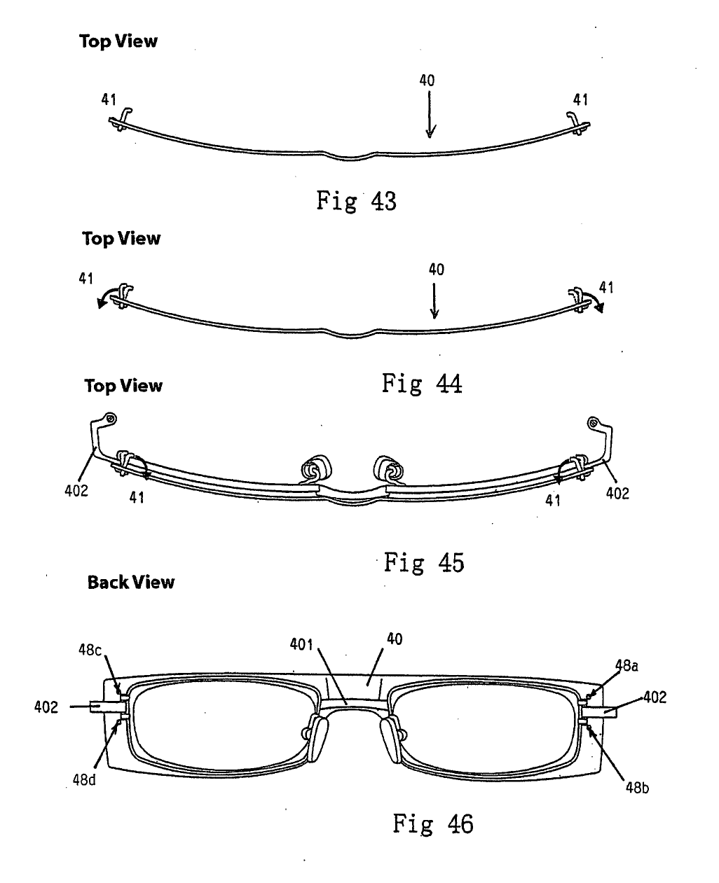

FIG. 36 to 46 illustrate the fourth embodiment of the present invention wherein a plastic ornament 40, which appearance is similar to a pair of eyeglasses but has no members, having two tension adjustment stoppers 41 inlaid into the two end portions respectively of said ornament. The tension adjustment stoppers 41 applied in this embodiment is identical to the one applied in the third embodiment. However, the method of fixing the tension adjustment stoppers to said ornament is not the same as applied in the foregoing embodiments. Two holes 46a, 46b at the right end portion and another two holes 46c, 46d at the left end portion of said ornament are made. The elongated portions 42a, 42b of the tension adjustment stoppers 41 are inserted into said two holes 46a and 46b, 46c and 46d respectively in a direction that the elongated portions extend backwardly to the rear side of said ornament. The hooks 43a, 43b of the elongated portions 42a, 42b of the two tension adjustment stoppers 41 are opposite and paralleled to each other. The tension adjustment stoppers 41 are still linking by nylon strings with two string-receiving apertures 45a. 45b pre-cast at the rectangular base portion but they are fixed to the ornament entirely by the knots of the nylon strings themselves. FIG. 46 illustrates that two small holes 48a, 48b are drilled at a position adjacent to the holes 46a, 46b for insertion of the elongated portions 42a, 42b of the tension adjustment stopper 41. A knot is made at one end portion of the nylon string forming a locking knot at 48a. The other end portion of the nylon string 44 is threaded through the locking knot 48a of said ornament in a direction from the rear side to the front. Said end portion of the nylon string then extends to pass through the string-receiving aperture 45a from top to bottom and the string-receiving aperture 45b from bottom to top of the tension adjustment stopper 41 as shown in FIG. 37. The end portion of the nylon string is then threaded through the other locking hole 48b at end portion of said ornament in a direction from the front to the back. Finally, tighten up the nylon string and to make another knot at the locking hole 48b to complete the affixing of the tension adjustment stopper 41 to said ornament 40. The method of affixing the tension adjustment stopper 41 on the left side of said ornament will be the same and the locking holes 48c, 48d are shown in FIG. 46. FIG. 44 and 45 illustrate that the tension adjustment stoppers 41 on both sides can be opened outwardly as a result of the elasticity inherent in nylon string. To place said ornament onto a pair of primary eyeglasses 401, users may simply pull the elongated portions of the tension adjustments outwardly and to close them immediately the elongated portions of the tension adjustment stoppers will be inlaid to the extensions 402 on both sides of the primary eyeglasses 40 wherein the upper elongated portion 42a is above the extensions 402 and the lower elongated portion 42b is below the extensions 402 performing like a clip. From the back view of the fourth embodiment as shown in FIG. 46, the rims on both sides of the primary eyeglasses 40 are caught by the hooks 43a, 43b of the elongated portions 42a, 42b of the tension adjustment stoppers 41. In this preferred embodiment, the frame or the lenses of said ornament needs no string-receiving groove on the outer peripheral rim surface.

From the above description, it can be understood that the application of the present invention is not limited to eyeglasses frames made of metal but is also applicable to plastic eyeglass frames.

What is claimed is:

1. A pair of eyeglasses comprises
a frame having two opposite ends,
a pair of lenses installed within and supported by said frame,
a bridge portion connection the rims of the frame,
two members at each end connecting said frame,
a pair of extensions at each end connecting the members.

2. The primary eyeglasses as recited in claim 1 wherein said frame is made of metal.

3. An eyeglass ornament removably attachable to said primary eyeglasses, said ornament comprises:
a device similar to an eyeglass frame or a semi-frame, depending upon the prescription of said pair of eyeglasses,
said ornament is made of metal or plastic material,
a pair of sun-lenses installed within and supported by said ornament, alternatively, no lenses at all are installed therewith,
two to four tension adjustment stoppers made of metal,
two pieces of nylon strings wherein one is for connection of said tension adjustment stopper(s) to the right rim and the other is for connection of said tension adjustment stopper(s) to the left rim,
two tension adjustment locking apertures at the top end portion of the rim if said ornament is made of metal,
two tension adjustment locking apertures at the bottom end portion of the rim if said ornament is made of metal,
two apertures at each end of said ornament for insertion of the elongated portions of said tension adjustment stopper if said ornament is made of plastic,
two string-locking apertures at each end of said ornament if said ornament is made of plastic.

4. An eyeglass ornament as claimed in claim 3 wherein the prescription of said ornament will affect the number of said tension adjustment stopper to be installed to said ornament.

5. An eyeglass ornament as claimed in claim 3 wherein said sun-lenses installed within and supported by said frame may be either sun-lenses or no lens at all.

6. An eyeglass ornament as claimed in claim 5 wherein each of said sun-lenses has a string-receiving groove which opens through the outer peripheral rim surface, and said string-receiving groove which is formed, for example, cut or punched, and the width of the string-receiving groove, in the circumferential direction of said sun-lens, is slightly greater than that the diameter of said nylon string, and the inner end of the string receiving groove is radiused and chamfered, beveled and padded to minimize stresses on, and chafing of, said nylon string.

7. An eyeglass ornament as claimed in claim 3 wherein said tension adjustment stopper is made of metal having a rectangular base portion and two elongated portions in equal length extending backwardly with a hook at each end, and each hook is stalled with a slipcover made of plastic material.

8. An eyeglass ornament as claimed in claim 7 wherein the shape of said tension adjustment stopper may be varied in order to fit in the prescription of the frame of the primary eyeglasses, said tension adjustment stopper is made of metal having a rectangular base portion and one elongated portion extending backwardly with a hook at its end, and said hook is stalled with a slipcover made of plastic material, such tension adjustment stopper having a single elongated portion is adapted for the frame of the primary eyeglasses has no side rim on both ends.

9. An eyeglass ornament as claimed in claims 7 wherein said tension adjustment stopper with two elongated portions has two-string receiving apertures on the rectangular base portion at a position between two elongated portions in equal distance.

10. An eyeglass ornament as claimed in claim 8 wherein said tension adjustment with one elongated portion has two string-receiving apertures and said two string-receiving apertures will be on the rectangular base portion in the position above and below the elongated portion in equal distance.

11. An eyeglass ornament as claimed in claim 3 wherein one piece of said nylon strings is the instrument for the connection of and the fastening of said tension adjustment stoppers to said sun-lens to the right rim of said ornament, wherein one end portion of said nylon string is threaded through a first tension adjustment locking aperture on the right end portion of the rim from bottom to top in a direction towards the bridge portion, and said nylon string is threaded through a second tension adjustment locking aperture from top to bottom, the other end portion of said nylon string extends with tension towards a first tension adjustment stopper at right top corner, wherein said end portion is threaded through a first string-receiving aperture of said tension adjustment stopper from bottom to top, and said end portion of said nylon string is threaded through a second string-receiving aperture from top to bottom, said end portion further extends with tension towards a second tension adjustment stopper at right bottom corner and it is again threaded through a first string-receiving aperture from bottom to top and is then threaded through a second string-receiving aperture from top to bottom, said end portion of the nylon string further extends with tension towards said tension adjustment locking apertures at the bottom rim of said ornament, said end portion is threaded through a first tension adjustment locking aperture from bottom to top and is then threaded through a second tension adjustment locking aperture from top to bottom to complete the connection of said two tension adjustment stoppers to the right rim of said ornament.

12. An eyeglass ornament as claimed in claim 3 wherein another piece of said nylon string is the instrument for the connection of and the fastening of said tension adjustment stoppers to said sun-lenses to the left rim of said ornament, wherein one end portion of said nylon string is threaded through a first tension adjustment locking aperture on the left end portion of the rim from bottom to top in a direction towards the bridge portion, and said nylon string is threaded through a second tension adjustment locking aperture from top to bottom, the other end portion of said nylon string extends with tension towards a first tension adjustment stopper at left top corner, wherein said end portion is threaded through a first string-receiving aperture of said tension adjustment stopper from bottom to top, and said end portion of said nylon string is threaded through a second string-receiving aperture from top to bottom, said end portion further extends with tension towards a second tension adjustment stopper at left bottom corner and it is again threaded through a first string-receiving aperture from bottom to top and is then threaded through a second string-receiving aperture from top to bottom, said end portion of the nylon string further extends with tension towards said tension adjustment locking apertures at the bottom rim of said ornament, said end portion is threaded through a first tension adjustment locking aperture from bottom to top and is then threaded through a second tension adjustment locking aperture from top to bottom to complete the connection of said two tension adjustment stoppers to the left rim of said ornament.

13. An eyeglass ornament as claimed in claim 3 wherein each of said nylon string lies on said string-receiving groove on the outer peripheral rim surface of said sun-lens and each of the end portion of said nylon string will be cut off at a length ranging from 4 to 6 mm from said second tension adjustment locking apertures at top and bottom and both end portions of said nylon string will be covered by the frame of said ornament.

14. An eyeglass ornament as claimed in claim 3 wherein the elongated portions of said tension adjustment stopper will be inserted to said two apertures at each end of said ornament in a direction from the front to the back leaving the rectangular base portion with said two string-receiving apertures in the front side if said ornament is made of plastic.

15. An eyeglass ornament as claimed in claim 14 wherein one piece of said nylon strings is the instrument for the connection of and the fastening of said tension adjustment stopper to the right end portion of said ornament, wherein one end portion of said nylon string is threaded through a first string-locking aperture on the right end portion in a direction from the front towards the back and a knot is made at the end portion of said nylon string forming a locking device, the other end portion of said nylon string is threaded through a first string-receiving aperture of said tension adjustment stopper from top to bottom and is threaded through a second string-receiving aperture from bottom to top, said end portion further passes through a second tension adjustment locking aperture in a direction from the front to the back and another knot is also made by said end portion of said nylon string forming another locking device to complete the connection of said tension adjustment stoppers on the right end portion of said ornament.

16. An eyeglass ornament as claimed in claim 14 wherein another piece of said nylon strings is for the connection of and the fastening of said tension adjustment stopper to the left end portion of said ornament, wherein one end portion of said nylon string is threaded through a first string-locking aperture on the left end portion in a direction from the front towards the back and a knot is made at the end portion of said nylon string forming a locking device, the other end portion of said nylon string is threaded through a first string-receiving aperture of said tension adjustment stopper from top to bottom and is threaded through a second string-receiving aperture from bottom to top, said end portion further passes through a second tension adjustment locking aperture in a direction from the front to the back and another knot is also made by said end portion of said nylon string forming another locking device to complete the connection of said tension adjustment stoppers on the left end portion of said ornament.

17. An eyeglass ornament as claimed in claim 3 wherein the width of said tension adjustment locking aperture is determined depending upon the diameter of said nylon string applied thereto.

18. An eyeglass ornament as claimed in claim 3 wherein said aperture for the insertion of the elongated portions of said tension adjustment stopper is determined depending upon the diameter of said nylon string applied thereto.

19. An eyeglass ornament as claimed in claim 3 wherein said string-receiving locking aperture is determined depending upon the diameter of said nylon string applied thereto.

20. An eyeglass ornament as claimed in claim 3 wherein the diameter and the tensile force of said nylon string are determined depending upon the shape and design of the eyeglass frame.
